(19) United States
(12) Patent Application Publication
(10) Pub. No.: US 2008/0128185 A1
(43) Pub. Date: Jun. 5, 2008

(54) Tool Cart having electric motor powered wheels

(76) Inventor: Chih-Ching Hsieh, Taichung (TW)

Correspondence Address: Chih-Ching Hsieh, 235 Chung - Ho, Box 8-24, Taipei, omitted

(21) Appl. No.: 11/633,228

(22) Filed: Dec. 5, 2006

(51) Int. Cl. B60P 3/00

(52) U.S. Cl. 180/54.1

(57) ABSTRACT

A tool cart has a front end and a rear end. A bottom of the tool cart having wheels includes at least one front wheel and at least one rear wheel; the tool cart being installed with a driving device for driving the wheels to rotate. The tool cart is installed with a handle for controlling the tool cart. The tool cart has at least one actuating switch installed near the handle for actuating the driving device. The user can actuate the actuating switch by operating the actuating switch so as to control the moving ways of the wheels. The driving device is installed within the tool cart. The driving device is installed at a rotary shaft of each rear wheel. Each front wheel is rotatable without being controlled by the driving device. The actuating switch is installed on the handle for controlling the rotation of each wheel.

### FIELD OF THE INVENTION

The present invention relates to tool carts, and particularly to a tool cart with a driving device, which can control the wheels of the tool cart to move along different moving ways.

### BACKGROUND OF THE INVENTION

In the prior art tool cart, the tool cart has a cabinet. Wheels are installed below the cabinet. A front end of the cabinet has a handle. The interior of the cabinet is installed with hanging holes. The cabinet is installed with sliding tracks within the cabinet. Each of upper end and lower end of the cabinet is extended with a lateral sheet. The upper lateral sheet is formed with a slit. The track is installed with a guide wheel. The cabinet has drawers each of which is extended with a stand post. A rear end of the post is pivotally installed with a pulley. The drawer is installed in the track. An outer side of the drawer has a through hole.

However the above mentioned prior art tool cart is pushed manually. A great manpower is needed. Thereby the tool cart occupy a large space.

### SUMMARY OF THE INVENTION

Accordingly, the primary object of the present invention is to provide a tool cart with a driving device, which can control the wheels of the tool cart to move along different moving ways.

To achieve above objects, the present invention provides a tool cart having a front end and a rear end. A bottom of the tool cart having wheels includes at least one front wheel and at least one rear wheel; the tool cart being installed with a driving device for driving the wheels to rotate. The tool cart is installed with a handle for controlling the tool cart. The tool cart has at least one actuating switch installed near the handle for actuating the driving device. The user can actuate the actuating switch by operating the actuating switch so as to control the moving ways of the wheels. The driving device is installed within the tool cart. The driving device is installed at a rotary shaft of each rear wheel. Each front wheel is rotatable without being controlled by the driving device. The actuating switch is installed on the handle for controlling the rotation of each wheel.

The various objects and advantages of the present invention will be more readily understood from the following detailed description when read in conjunction with the appended drawing.

### BRIEF DESCRIPTION OF THE DRAWINGS

FIG. 1 is a schematic view of the tool cart of the present invention.

FIG. 2 is a schematic cross sectional view of the tool cart of the present invention.

FIGS. 3 and 4 are schematic views showing the application of the present invention.

FIG. 5 is a schematic view showing the second embodiment of the present invention.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

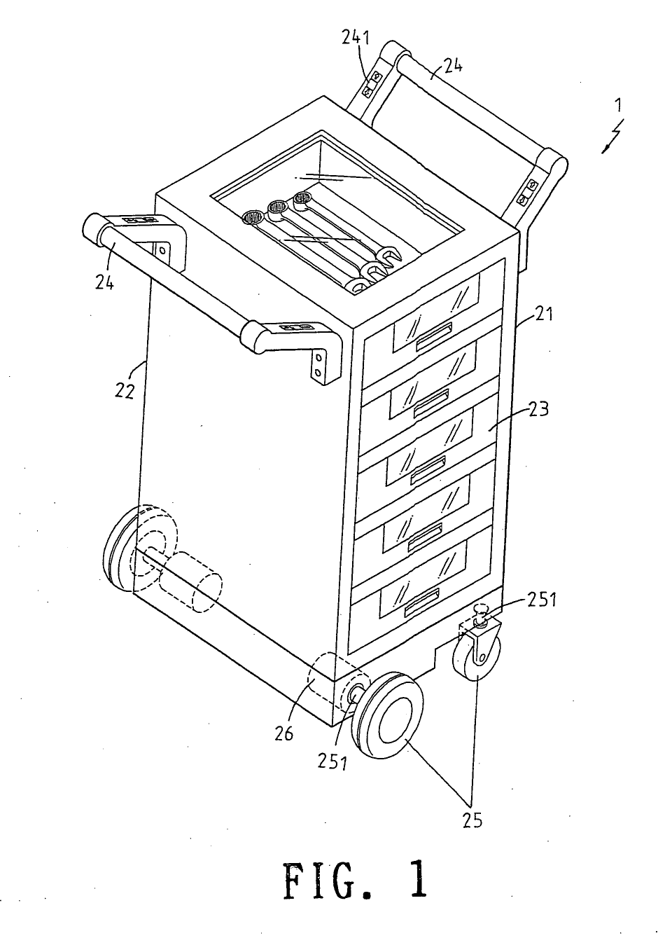

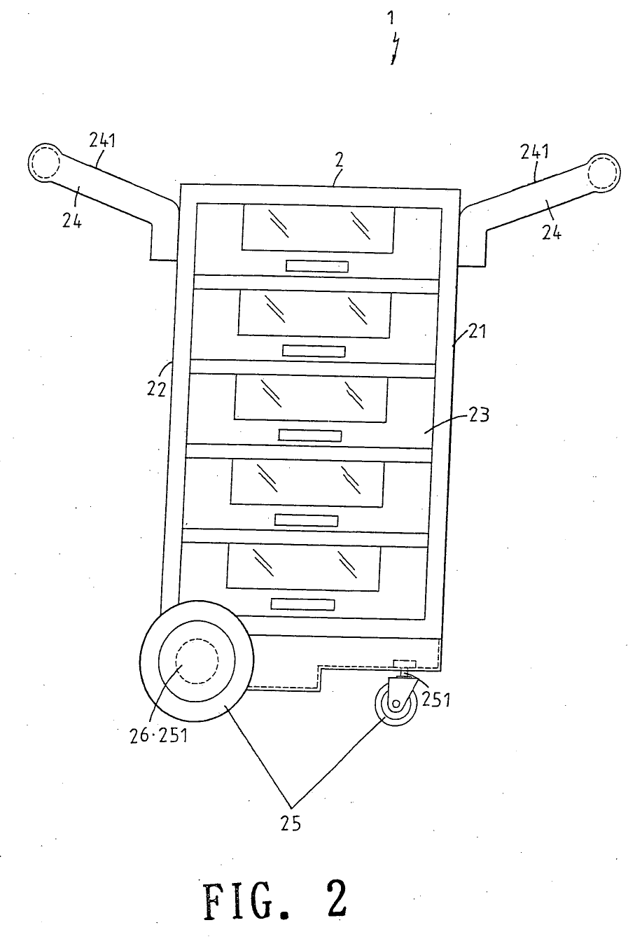

Referring to FIGS. 1 and 2, the structure of the present invention is illustrated. The car body 1 of the present invention has the following elements.

A tool cart 2 has a main body 23 for receiving various hand tools. The tool cart 2 has a front end 21 and a rear end 22. The front end 21 and rear end 22 has respective handles 24 for being held by users. Each of two sides of each handle 24 has an actuating switch 241.

A bottom of the tool cart 2 has four wheels 25 including two front wheels 25 and two rear wheels 25. Each front wheel 25 is installed with a rotary shaft 251. The rotary shaft 251 of the front wheel 25 is bent to be connected to a bottom surface of the tool cart 2 so that the two front wheels 25 are rotatable. The two rear wheels 25 are also installed with rotary shafts 251. The rotary shaft 251 of the rear wheel 25 is connected to a lateral side of the tool cart 2.

A driving device 26 is installed within the tool cart 2. The driving device 26 is controlled by an actuating switch 241. The actuating switch 241 is installed with a plurality of buttons for controlling the forward rotation, backward rotation, whole turning and stop of the tool cart 2.

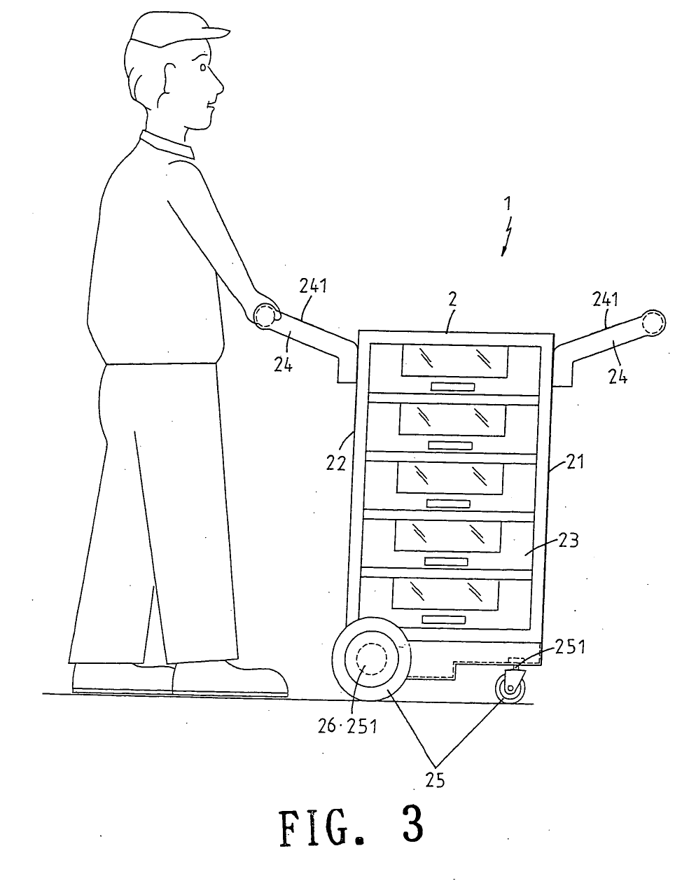

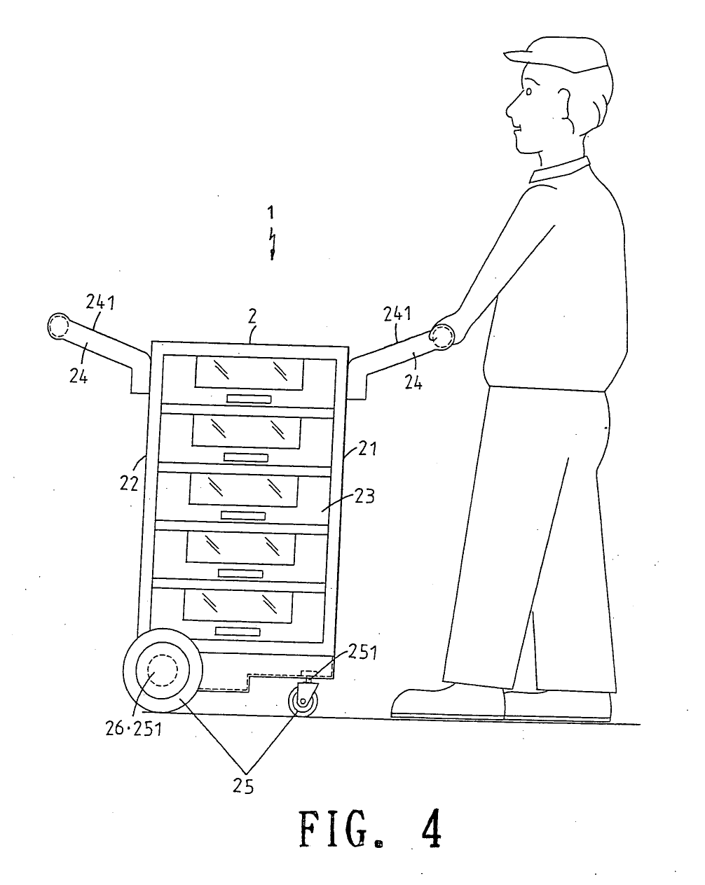

Referring to FIGS. 3 and 4, in application, the user can press the actuating switches 241 at two sides for adjusting the wheels at the same moving mode. The driving device 26 is controlled by the actuating switches 241 to adjust the two rear wheels 25 to move by the same way, such as move forwards or backwards. Further, the front end 21 and rear end 22 have respective handles 24. Any user can press the actuating switch 241 at any handle 24 without needing to change position. Moreover, the user can press the actuating switches 241 at the front end 21 and the rear end 22 so that they are operated at different moving ways, for example the two rear wheels 25 rotate with different ways, and the two front wheels 25 pivotally rotate freely. Therefore, the tool cart 2 can rotate leftwards or rightwards or rotates through 360 degrees.

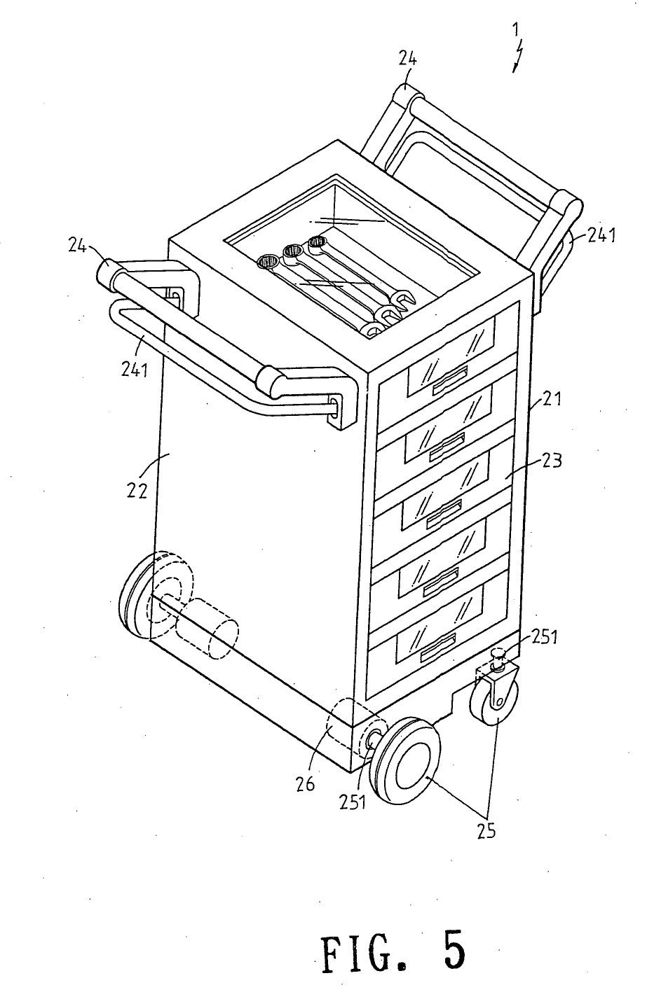

Referring to FIG. 5, the second embodiment of the present invention is illustrated. In this embodiment, those identical to the above embodiment will not be further described herein. Only those different from above embodiment are described. In this embodiment, each handle 24 has a respective actuating switch 241 which is installed below the handle 24 and has the same shape as the handle 24. The actuating switch 241 can pivotally rotate along the handle 24 in a finite range. Thus the user can hold the handle 24 and press the actuating switch 241 at the same time for controlling the moving way of the tool cart 2. Thereby the user can control the tool cart 2 by only one hand.

Furthermore, in the present invention, the number of the handle 24 may be one, which is installed at the front end 21 or rear end 22.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A tool cart with a driving device; the tool cart having a front end and a rear end; a bottom of the tool cart having wheels including at least one front wheel and at least one rear wheel; the tool cart being installed with a driving device for driving the wheels to rotate; the tool cart being installed with a handle for controlling the tool cart; the tool cart having at least one actuating switch installed near the handle for actuating the driving device; and
wherein the user can actuate the actuating switch by operating the actuating switch so as to control the moving ways of the wheels.

2. The tool cart as claimed in claim 1, wherein the driving device is installed within the tool cart.

3. The tool cart as claimed in claim 1, wherein the driving device is installed at a rotary shaft of each rear wheel.

4. The tool cart as claimed in claim 1, wherein each front wheel is rotatable without being controlled by the driving device.

5. The tool cart as claimed in claim 1, wherein the actuating switch is installed on the handle for controlling the rotation of each wheel.

6. The tool cart as claimed in claim 1, wherein the actuating switch is parallel to the handle and is installed near the handle for controlling the rotation of the wheel.
